(19) United States
(12) Patent Application Publication
(10) Pub. No.: US 2003/0124458 A1
(43) Pub. Date: Jul. 3, 2003

(54) Information recording medium and information recording method

(75) Inventors: Minoru Ichijo, Kitasoma-gun (JP); Yoshihiro Ikari, Kitasoma-gun (JP); Reiji Tamura, Kitasoma-gun (JP); Hitoshi Watanabe, Yuki-gun (JP); Hidetaka Matsumuro, Yuki-gun (JP)

Correspondence Address: BIRCH STEWART KOLASCH & BIRCH, PO BOX 747, FALLS CHURCH, VA, 22040-0747, US

(73) Assignee: Hitachi Maxell, Ltd., Osaka (JP)

(21) Appl. No.: 10/330,245

(22) Filed: Dec. 30, 2002

Related U.S. Application Data
(62) Division of application No. 09/744,883, filed on Jan. 31, 2001, now abandoned.
Application No. 09/744,883 is a 371 of international application No. PCT/JP99/04110, filed on Jun. 30, 1999.

(30) Foreign Application Priority Data
Jul. 31, 1998 (JP) 10/229535

(51) Int. Cl. G11B 7/24

(52) U.S. Cl. 430/270.13; 430/945; 428/64.5; 369/275.2

(57) ABSTRACT

An information recording medium has a substrate and a recording layer on the substrate, the recording layer is partially transformable between a crystalline state and an amorphous state by being partially heated and cooled so that a signal is recorded in the recording layer by the partial transformation, and the recording layer includes oxygen.

### TECHNICAL FIELD RELATING TO THE INVENTION AND PRIOR ART

The present invention relates to an information recording medium whose recording layer is partially transformable between crystalline state and amorphous state by being heated and cooled so that a signal is recorded in the recording layer with the partial deformation of the recording layer, and a method for recording an information in the information recording medium.

JP-A-61-2594 discloses that a mixture of tellurium and tellurium oxide as a recording layer including oxygen is deposited on a recording medium substrate by an electron-beam vapor deposition or sputtering.

JP-A-2-252577 discloses that a compound including tellurium is deposited on the recording medium-substrate by a sputtering in a gas mixture of argon and oxygen to form the recording layer including oxygen.

JP-A-63-58636 discloses that a compound including germanium oxide and tellurium as the recording layer including oxygen is deposited on the recording medium substrate by the electron-beam vapor deposition, and a compound including tellurium is deposited on the recording medium substrate by the sputtering in the gas mixture of argon and oxygen to form the recording layer including oxygen.

### OBJECT AND SUMMARY OF THE INVENTION

An object of the present invention is to provide an information recording medium and an information recording method, by which medium and method a change of a recorded information with the passage of time is restrained, and/or the recorded information is clearly and securely read out. Particularly, the object of the present invention is to provide the information recording medium and the information recording method, in which medium and method a crystalline state part of recording layer surrounding an amorphous part of recording layer is prevented from growing epitaxially into the amorphous part of recording layer, and/or a boundary between the amorphous part of recording layer and the crystalline state part of recording layer surrounding the amorphous part of recording layer is clear and smooth.

In a wide spread of so-called optical disks during the recent years, the optical disks become to be used and stored under more severe conditions. Therefore, it is necessary to improve a reliability of the optical disks. As a result of various durability experiments regarding the above described materials in this view point, is was found that a signal quality such as jitter was deteriorated after a long term storage of the disk with the recorded information under high temperature and humidity severe environment. By detailed investigation about this, it was found that a crystalline part contacting an amorphous mark grows epitaxially to change a shape of the amorphous mark. It was also found that no change occurs at a central area of the amorphous mark, that is, a portion not contacting the crystalline state. For overcoming this problem, a material and composition of a recording layer are changed to increase an activating energy of the recording layer so that a stability of the amorphous is increased, but, the similar phenomenon occurred. From these matters, it was understood that this phenomenon cannot be overcome by increasing the activating energy of the amorphous state to improve a thermal stability of the amorphous state, and an improvement on a new point is necessary. The inventors found from various considerations for overcoming the above problem that an improvement of an interface between the amorphous mark and the crystalline state part in the recording layer is significantly important, and the above problem can be overcome by adjusting a content of oxygen in the recording layer.

In an information recording medium comprising a substrate and a recording layer on the substrate, the recording layer being partially transformable between a crystalline state and an amorphous state by being partially heated and cooled so that a signal is recorded in the recording layer by the partial transformation, oxygen included by the recording layer restrains a change of the transformed part, particularly a recrystallization of the part of the recording layer transformed from the crystalline state to the amorphous state, so that a change of the recorded information in the passage of time is restrained. As the recording layer, materials of GE-Sb—Te type, In—Sb—Te type, Ag—In—Sb—Te type, MA-Ge—Sb—Te type (MA involves at least one of Au, Cu, Pd, Ta, W, Ir, Sc, Y, Ti, Zr, V, Nb, Cr, Mo, Mn, Fe, Ru, Co, Rh, Ni, Ag, Tl, S, Se and Pt), Sn—Sb—Te type, In—Se—Tl type, In—Se—Tl-MB type (MB involves at least one of Au, Cu, Pd, Ta, W, Ir, Sc, Y, Ti, Zr, V, Nb, Cr, Mo, Mn, Fe, Ru, Co, Rh, Ni, Ag, Tl, S, Te and Pt), Sn—Sb—Se type or the like is usable.

If a content of oxygen in the recording layer is less than 2 atom % of a total content of all atoms in the recording layer, it is difficult to obtain a stability of the recorded mark formed by the partial transformation of the recording layer. If the content of oxygen in the recording layer is more than 20 atom %, it is difficult to easily carry out the transformation between the crystalline state and the amorphous state. For increasing the stability of the recorded mark, 3-15 atom % is preferable, and 8-14 atom % is more preferable.

It enables the recording layer to maintain stably the oxygen in the recording layer and restrains in the recording layer a diffusion of a constituent part from and/or into the amorphous state part and/or the crystalline state part, and/or a crystalline growth from the crystalline state part into the amorphous state part, that the recording layer includes the oxygen as oxide.

If the recording layer includes Ge, Sb and Te, it is preferable for the recording layer to include at least a part of Ge as oxide. It is preferable for a relationship between a content a of the at least a part of Ge as oxide in the recording layer and a content b of another part of Ge in the recording layer other than the at least a part of Ge as oxide to be within a scope defined by (0.02≦a/(a+b)≦0.5).

If the recording layer includes Ge, Sb and Te, it is preferable for the recording layer to include at least a part of Sb as oxide. It is preferable for a relationship between a content c of the at least a part of Sb as oxide in the recording layer and a content d of another part of Sb in the recording layer other than the at least a part of Sb as oxide to be within a scope defined by (0.01≦c/(c+d)≦0.2).

When the recording layer includes Ge, Sb and Te, and contents of respective atoms are 10-30 atom % of Ge, 10-30 atom % of Sb and 40-80 atom % of Te, or 35-65 atom % of Ge, 10-30 atom % of Sb and 35-65 atom % of Te, a phase change between the amorphous phase and the crystalline phase can be easily carried out so that a rewrite of the information is easy. By adding another atom of 1-10 atom %, for example, at least one of Au, Cu, Pd, Ta, W, Ir, Sc, Y, Ti, Zr, V, Nb, Cr, Mo, Mn, Fe, Ru, Co, Rh, Ni, Ag, Tl, S, Se, Pt and N of 1-10 atom %, a temperature for crystallization of the amorphous state is increased, or an activating energy is increased.

When the recording layer includes Ag, In, Sb and Te, it is preferable for the recording layer to include at least a part of In as oxide. It is preferable for a relationship between a content e of the at least a part of In as oxide in the recording layer and a content f of another part of In in the recording layer other than the at least a part of In as oxide to be within a scope defined by (0.01≦e/(e+f)≦0.5).

When the recording layer includes Ag, In, Sb and Te, it is preferable for the recording layer to include at least a part of Sb as oxide. It is preferable for a relationship between a content g of the at least a part of Sb as oxide in the recording layer and a content h of another part of Sb in the recording layer other than the at least a part of In as oxide to be within a scope defined by (0.01≦g/(g+h)≦0.2).

When the recording layer includes Ag, In, Sb and Te, and contents of respective atoms are 1-15 atom % of Ag, 1-15 atom % of In, 45-80 atom % of Sb and 20-40 atom % of Te, the phase change between the amorphous phase and the crystalline phase can be easily carried out so that the rewrite of the information can be performed. By adding another atom of 1-10 atom %, for example, at least one of Au, Cu, Pd, Ta, W, Ir, Sc, Y, Ti, Zr, V, Nb, Cr, Mo, Mn, Fe, Ru, Co, Rh, Ni, Ag, Tl, S, Se, Pt and N of 1-10 atom %, the temperature for crystallization of the amorphous state is increased, or the activating energy is increased.

The recording layer is partially heated by a light beam or an electron-beam.

By making the recording layer include oxygen, the oxygen or oxide prevents at least partially a direct contact between the amorphous phase and the crystalline phase to prevent an epitaxial crystalline growth so that a stability of the amorphous mark is increased.

If the recording layer includes oxygen as oxide in the recording layer, and a viscosity of a part of the recording layer is kept high by the oxide included by the part of the recording layer to keep a surface tension of the part of the recording layer high when the part of the recording layer is heated to be melted, so that at least a part of a boundary between the part of the recording layer melted and subsequently cooled to be cured and another part of the recording layer surrounding the part of the recording layer is round and smooth, one of “0” state and “1” state of the signal is clearly and securely defined by the round and smooth at least a part of the boundary when recording the signal onto the recording layer and is clearly and securely recognized at the at least a part of the boundary when reading out the signal from the recording layer. The part of the recording layer after being cooled to be cured may be in the amorphous state, and the another part of the recording layer may be in the crystalline state, or alternatively, the part of the recording layer after being cooled to be cured may be in the crystalline state, and the another part of the recording layer may be in the amorphous state.

The above method is significantly effective, particularly when a recording density is increased.

When by forming a spiral groove, or a plurality of coaxial grooves on the substrate, the substrate includes a plurality of grooves extending substantially circumferentially and juxtaposed radially and a plurality of land portions extending substantially circumferentially and juxtaposed radially between the grooves and juxtaposed radially, and at least one of the plurality of grooves juxtaposed radially and the plurality of land portions juxtaposed radially forms recording tracks on which the signal is recorded, the smaller a radial distance between the recording tracks is, the larger the recording density is. If the radial distance between the recording tracks is not more than 1 μm, an effect of the above method is increased, and if not more than 0.7 μm, the effect is particularly increased.

Further, the smaller a minimum length of a part of the recording layer melted and subsequently cooled to be cured, that is, the recorded mark is, the larger the recording density is. Since an magnitude of a deformation of the mark shape by the epitaxial crystalline growth at the mark boundary in comparison with a size of the mark and an effect on the signal quality by the deformation of the mark shape are increased when the minimum length of the recorded mark in the substantially circumferential direction is not more than 0.7 μm, the effect of the above method is increased. When the minimum length of the recorded mark in the substantially circumferential direction is not more than 0.5 μm, the effect of the above method is further increased.

If the medium further comprises a protecting layer contacting the recording layer and the protecting layer includes at least one of oxygen and nitrogen, a discharge of oxygen out of the recording layer is restrained to hold stably the oxygen in the recording layer. When the protecting layer includes the oxygen, since the recording layer includes the oxygen, a diffusion of oxygen from the protecting layer into the recording layer is restrained. When the protecting layer includes the nitrogen, a change of the recording layer from the amorphous state to the crystalline state, that is, a crystalline growth of a part of the recording layer of the crystalline state into a part of the recording layer of the amorphous state is restrained.

It is preferable that a content of nitrogen in the protecting layer is 1-50 atom % of a total content of all components of the protect layer. It is preferable that the protecting layer includes ZnS and SiO₂. If the protecting layer includes at least one of chrome oxide, tantalum oxide, aluminum oxide and germanium nitride, a diffusion of component between the protecting layer and the recording layer is restrained and components of the recording layer are stable. When the protecting layer includes the nitrogen, a content thereof is preferably 1-50 atom %. Further, it is more preferable for a gradient of nitrogen content in a layer thickness direction in a region at which the recording layer and the protecting layer are adjacent to each other is 1-50 atom %/nm. Under this condition, when the recording layer is heated to a high temperature not more than a melting point thereof by an energy beam such as a laser beam, a crystalline nucleus is easily generated at the region at which the recording layer and the protecting layer are adjacent to each other so that a phase change from the amorphous phase to the crystalline phase, that is, a deletion of the recorded mark is easy. That is, a superior rewriteable medium is obtainable, because a maintenance stability in a room temperature and a superior deleting performance in a high temperature of the amorphous mark can be obtained by controlling the oxygen content of the recording layer and the nitrogen content of the protecting layer. A mixture of ZnS and SiO₂ is preferable as a material of the protecting layer, because of its low thermal conductivity and good recording sensitivity. However, there is a possibility of that S in this material diffuses into the recording layer by a plurality of rewritings not less than 100000 times to change an optical coefficient of the recording layer so that a reflectance is decreased. And, the chrome oxide, tantalum oxide, aluminum oxide and germanium nitride are usable as the material of the protecting layer. In these, the chrome oxide involves a superior point of that the optical coefficient is large to increase a difference in reflectance between the amorphous phase and the crystalline phase with a multiple interference effect, and an inferior point of that a stress is large in accordance with a layer deposition condition. The tantalum oxide involves a superior point of that a cooling effect after the recording layer is heated and melted is increased by its large thermal capacity, and an inferior point of that a loss of oxygen easily occurs so that it absorbs the light and the reflectance is decreased. The aluminum oxide involves a superior point of that it is significantly stable and an inferior point of that an adhesive force to the recording layer is small. The germanium nitride involves a superior point in adhesive force to the recording layer, and an inferior point of that a bulk thereof is fragile and thereby forming a layer thereof through sputtering or the like is difficult. These materials of the protecting layer have the superior points and inferior points respectively, but mixtures thereof compensate the inferior points to have only the superior points. For example, a combination of the chrome oxide and the aluminum oxide, a combination of the chrome oxide and the germanium nitride, a combination of the tantalum oxide and the aluminum oxide, a combination of the aluminum oxide and the germanium nitride and so forth are the mixtures. Further, another material other than the above described materials may be added to the above protecting layer materials. As the another material other than the above described materials, CeO₂, La₂O₃, SiO, In₂O₃, GeO, GeO₂, PbO, SnO, SnO₂, Bi₂O₃, TeO₂, Sc₂O₃, Y₂O₃, TiO₂, ZrO₂, V₂O₅, Nb₂O₅, WO₂, WO₃, CdS, CdSe, ZnSe, In₂S₃, In₂Se₃, Sb₂S₃, Sb₂Se₃, Ga₂S₃, Ga₂Se₃, GeS, GeSe, GeSe₂, SnS, SnS₂, SnSe, SnSe₂, PbS, PbSe, Bi₂Se₃, Bi₂S₃, MgF₂, CeF₃, CaF₂, TaN, Si₃N₄, AlN, CrN, BN, Si, TiB₂, B₄C, SiC, B, C or the like is usable.

When an oxygen concentration is a ratio of a number of oxygen atoms to a number of all atoms in a unit volume, and the oxygen concentration in the recording layer changes in a thickness direction of the recording layer, a characteristic of a component diffusion between a surface of the recording layer and a layer contacting the recording layer is desirably set, and changes in viscosity and reflectance between the surface of the recording layer and an interior of the recording layer can be desirably set. An adjustment of the oxygen concentration in the recording layer may be carried out by an oxidizing treatment of the recording layer in a gas including oxygen after the recording layer is formed, or an adjustment of oxygen concentration of an environment gas during a deposition of the recording layer.

When the oxygen concentration increases from a substantially middle point of the recording layer toward at least one of surfaces of opposite sides of the recording layer in the thickness direction of the recording layer, the component diffusion between the surface of the recording layer and the layer contacting the recording layer is restrained, and a reflectance at the substantially middle point of the recording layer under the amorphous phase is kept high.

When the oxygen concentration increases from the substantially middle point of the recording layer toward each of surfaces of opposite sides of the recording layer in the thickness direction of the recording layer, the component diffusion between the surface of the recording layer and each of the layers contacting the recording layer is restrained, and the reflectance at the substantially middle point of the recording layer under the amorphous phase is kept high.

It is preferable that the oxygen concentration increases from the substantially middle point of the recording layer toward the at least one of surfaces of opposite sides of the recording layer in the thickness direction of the recording layer by at least two times of the oxygen concentration at the substantially middle point of the recording layer.

When the medium further comprises a reflection layer for reflecting a light, the recording layer is arranged between the reflection layer and the substrate, the recording layer has a first surface relatively closer to the substrate in the thickness direction of the recording layer and a second surface relatively closer to the reflection layer in the thickness direction of the recording layer, and the oxygen concentration on the first surface (or the oxygen concentration at a first depth from the first surface) is lower than the oxygen concentration on the second surface (or the oxygen concentration at a second depth from the second surface, the second depth being substantially equal to the first depth), the oxygen concentration on the first surface is increased toward the oxygen concentration on the second surface with the oxidization of the first surface by the oxygen passing through the resin substrate to make the oxygen concentrations on the surfaces of opposite sides in the thickness direction of the recording layer uniform. The reflection layer is generally metallic, and an oxygen permeability thereof is smaller than that of the substrate made of a resin.

As a material used for the reflection layer, Au, Ag, Cu, Al or a material including at least one of them as a main component is preferable because of a significantly high reflectance thereof. When only one of them is used, the reflectance thereof is significantly high, but a recording sensitivity is decreased because of a significantly large thermal conductivity thereof. On the other hand, a material including at least one of Ti, Cr, Co, Ni, Sb, Bi, In, Te, Se, Si, Ge, Pb, Ga, As, Zn, Cd, Sc, V, Mn, Fe, Y, Zr, Nb, Mo, Tc, Ru, Rh, Pd, Hf, Ta, W, Re, Os, Ir, Pt, lanthanoid element and actinoid element as a main component thereof has a low reflectance, but a low thermal conductivity preferable for the recording sensitivity. A mixture of the element of the before mentioned group such as Au and the element of the later mentioned group such as Ti enables the reflection layer to have the high reflectance and the low thermal conductivity. Au—Co, Au—Cr, Au—Ti, Au—Ni, Ag—Cr, Ag—Ti, Ag—Ru, Ag—Pd, Ag—Cu—Pd, Al—Ti, Al—Cr, Al—Co, Al—Ni, Al—Nb or the like is a concrete example. Au—Ag and Au—Cu also can form the reflection layer of the high reflectance and low thermal conductivity.

When the oxygen concentration on the first surface (or the oxygen concentration at the first depth from the first surface) is higher than the oxygen concentration on the second surface (or the oxygen concentration at the second depth from the second surface, the second depth being substantially equal to the first depth), a pair of the recording layers is included by the information recording medium, the reflection layer is at a relatively inner side in comparison the substrate in the information recording medium, and a temperature at a relatively inner position is made higher than a temperature at a relatively outer position in the information recording medium by recording and/or reproducing, the oxygen concentration on the second surface is increased toward the oxygen concentration on the first surface with a proceeding of oxidization of the second surface by a diffusion of oxygen from the protecting layer so that the oxygen concentrations on the surfaces of opposite sides in the thickness direction of the recording layer are made uniform.

When the oxygen concentration increases from the substantially middle point of the recording layer toward the first surface in the thickness direction of the recording layer, the oxygen passing through the substrate is prevented from reaching the substantially middle point of the recording layer.

When the oxygen concentration increases from the substantially middle point of the recording layer toward the second surface in the thickness direction of the recording layer, the pair of the recording layers is included by the information recording medium, the reflection layer is at the relatively inner side in comparison the substrate in the information recording medium, and the temperature at the relatively inner position is made higher than the temperature at the relatively outer position in the information recording medium by the recording and/or reproducing, a proceeding of oxidization at the substantially middle point of the recording layer is restrained.

When the recording layer includes a first area on which the information can be recorded and a second area from which only a reproduction of the previously recorded information is performed, it is preferable that a difference in oxygen content between the first and second areas is not more than 18 atom %. It is preferable that the difference in oxygen content between the first and second areas is not more than 18 atom % after deleting the recorded signal and recording the signal on the first area is performed by a plurality of times so that the transformation of at least a part of the recording layer on the first area between the crystalline state and the amorphous state is repeated by the plurality of times.

When the difference in oxygen content between the first area on which the information can be recorded as described above and the second area on which only the reproduction of the previously recorded information is carried out is more than 18%, a difference in reflectance therebetween becomes large so that it is difficult for the informations on both of the first and second areas to be reproduced by similar methods. Generally, just after the recording layer is formed by sputtering or the like on the information recording medium including the first and second areas as described above, the oxygen contents of the first and second areas are substantially equal to each other so that the reflectances of the first and second areas are substantially equal to each other and a problem on the reproduction does not occur, but when the information is recorded on the second area by embossed pits, differences in oxygen diffusion with the passage of time and penetration of oxygen from an exterior may caused by a difference in shape relative to the first area on which only grooves and a intermediate area between the grooves for the recording are formed. Further, because a atomic configuration changes only on the first area of the recording layer when the recording is carried out by at least one time, the oxidization or a discharge of the oxide is accelerated in comparison with the second area of the recording layer. When the oxygen is previously included by the recording layer, it is difficult for the above problems to be raised and the difference in oxygen content between the first and second areas can be limited not more than 18% after the passage of time or the recordings of the plurality of times.

In an information recording method for recording a signal by transforming partially a recording layer between crystalline state and amorphous state, comprising the steps of: heating a part of the recording layer to be melted, and cooling the heated part of the recording layer to be cured so that a signal mark surrounded by another part of the recording layer other than the part of the recording layer is formed, the recorded signal involves “0” state and “1” state, one of the “0” state and the “1” state to be recorded is defined by at least a part of a boundary between the part of the recording layer and the another part of the recording layer, and the recorded one of the “0” state and the “1” state is recognized at the at least a part of the boundary, when the recording layer comprises oxygen as oxide to keep a viscosity and surface tension of the part of the recording layer high by the oxide included by the part of the recording layer when the part of the recording layer is heated to be melted, so that the at the at least a part of the boundary between the another part of the recording layer and the part of the recording layer cooled to be cured after being melted is round and smooth, the one of the “0” state and the “1” state is clearly and securely defined during the recording of the signal onto the recording medium and clearly and securely recognized during the reproduction of the signal from the information recording medium, by the round and smooth at least a part of a boundary between the part of the recording layer and the another part of the recording layer. The part of the recording layer after being cooled to be cured may be in the amorphous state, and the another part of the recording layer may be in the crystalline state, while the part of the recording layer after being cooled to be cured may be in the crystalline state, and the another part of the recording layer may be in the amorphous state. It is preferable that the part of the recording layer is heated to be melted by an irradiation of a light beam.

The recording layer may includes a first recording layer (4b) and a second recording layer (4a), the oxygen concentration may be changed abruptly between the first and second recording layer (in comparison with the oxygen concentration changes in the first and second recording layer), an oxygen concentration of the first recording layer as an average in a thickness direction may be not more than one-third of an oxygen concentration of the second recording layer as an average in the thickness direction, and a thickness of the first recording layer may be larger than a thickness of the second recording layer. The recording layer may include a plurality of the second recording layers, and the first recording layer may be arranged between the second recording layers.

### BRIEF DESCRIPTION OF THE DRAWINGS

FIG. 1 is a schematic sectional view showing a structure of a phase change. (transformation) type information recording medium;

FIG. 2a is a sectional view showing a substrate with grooves and lands raised relative to the grooves on a recording layer according to the present invention, taken along a radial direction;

FIG. 2b is a front view showing two embodiments of the substrate on which the recording layer according to the present invention is placed (a concentric surface shape forming a plurality of substantially circumferentially extending concentric grooves and lands juxtaposed in the radial direction, and a helical surface shape forming the plurality of the substantially circumferentially extending grooves lands juxtaposed in the radial direction);

FIG. 3 is a schematic diagram showing the relationship between a record mark and one of “1” status and “0” status of a signal to be read from the record mark or recorded by the record mark. The one of “1” status and “0” status of the signal is read and recorded when a level of the record signal is changed;

FIG. 4 is a schematic partial sectional view showing that the recording layer may be configured by a plurality of layers so that the concentration of oxygen is varied in a direction of thickness; and

FIG. 5 is diagram showing a relationship between the concentration of oxygen and a shortest length of a record mark and jitter after an accelerated test.

FIG. 6 is diagram showing a relationship among the concentration of oxygen, a track pitch and jitter after an accelerated test.

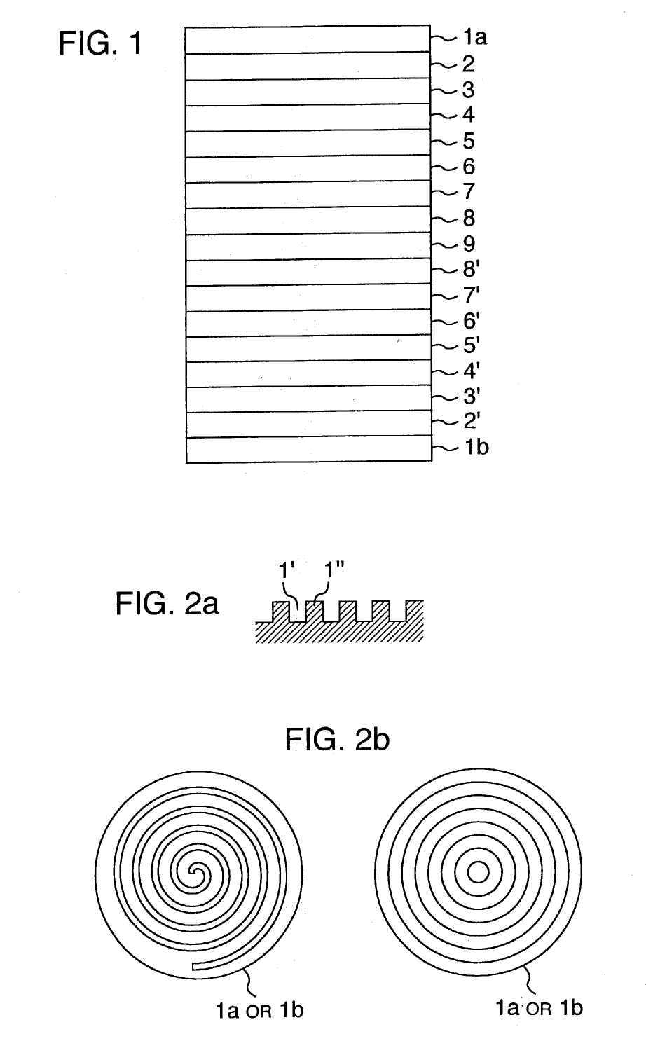

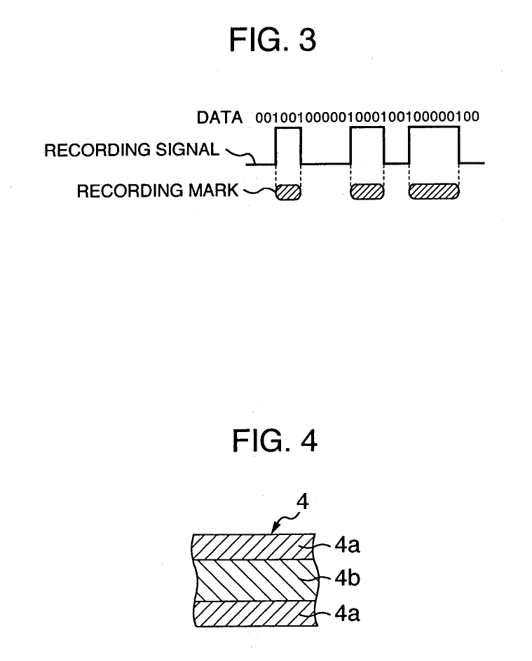

### PREFERRED EMBODIMENTS OF THE INVENTION

The present invention will be described below in detail by using embodiments.

[Embodiment 1]

A substrate 1a formed of transparent material of diameter of 120 mm and thickness of 0.6 mm (for embodiment, polycarbonate resin, glass or the like) with substantially circumferentially extending grooves 1′ and lands 1″ juxtaposed in the radial direction (that is, concentric or helical) as shown in FIG. 2 was prepared. In one embodiment, the radial distance between the center of the groove 1′ and the center of the adjacent land 1′ was 0.74 μm. This substrate la was placed in a first sputtering chamber in sputtering equipment having a plurality of sputtering chambers and providing good uniformity and reproducibility of layer thickness. A first overlaid layer 2 of (ZnS)₈₀(SiO₂)₂₀ (80 and 20 represent mol %) with thickness of 90 nm was formed on the substrate 1a by sputtering in argon gas with a mixture of ZnS and SiO₂ as a target. Then, after this substrate was moved into a second sputtering chamber, a first protective layer 3 of Cr₂O₃ with thickness of 20 nm was deposited by sputtering in argon gas with Cr₂O₃ as a target. Further, after this substrate was moved into a third sputtering chamber, a recording layer 4 was deposited in thickness of 16 nm by sputtering in argon gas with sintered Ag_{2.5}Ge₂₀Sb_{22.5}Te₅₅ (2.5, 20, 22.5 and 55 represent atomic %) as a target. Then, mixed gas of argon and oxygen with partial pressure of oxygen being 10% is flowed in the third sputtering chamber at a flow rate of 200 SCCM for a certain time period to oxidize the surface of a recording layer 4. Then, the substrate was moved into a fourth sputtering chamber, and a second protective layer 5 of (ZnS)₈₀(SiO₂)₂₀ (80 and 20 represent mol %) with thickness of 18 nm was deposited by sputtering similarly to the formation of the first overlaid layer. Then, in a fifth sputtering chamber, a first reflecting layer 6 of Al₉₄Cr₆ (94 and 6 represent atomic %) was deposited in thickness of 35 nm by sputtering, with AlCr alloy as a target. Finally, in a sixth sputtering chamber, a second reflecting layer 7 of Al₉₉Ti₁ (99 and 1 represent weight %) was deposited in thickness of 35 nm by sputtering, with AlTi alloy as a target. The substrate on which the protective layer, reflecting layer and overlaid layer were deposited was taken out of the sputtering equipment, and an ultraviolet cured resin protective layer 8 was applied on the top layer by spin coating.

In a similar way, a first overlaid layer 2′ of (ZnS)₈₀(Sio₂)₂₀ (80 and 20 represent mol %), a protective layer 3′ of Cr₂O₃, a recording layer 4′ of Ag_{2.5}Ge₂₀Sb_{22.5}Te₅₅, a second protective layer 5′ of (ZnS)₈₀(SiO₂)₂₀ (80 and 20 represent mol %), a first reflecting layer 6′ of Al₉₄Cr₆ (94 and 6 represent atomic %), a second reflecting layer 7′ of Al₉₉Ti₁ (99 and 1 represent weight %) and an ultraviolet cured resin protective layer 8′ are deposited on another similar substrate 1b, and the two substrates 1a, 1b were laminated in a face-to-face manner through the ultraviolet cured resin protective layers 8, 8′ inside the laminated substrate, using an adhesive layer 9. At this time, when the diameter of the adhesive layer is not less than 118 mm, separation at the adhesive layer due to impacts caused by such as dropping was more unlikely to occur. For the recording layer 4′, oxidization process was performed similarly to the recording layer 4.

After the recording layers 4, 4′ were formed, several kinds of disk samples with respective various contents or concentrations of oxygen in the recording layer formed by changing a period of time for applying a mixed gas of argon and oxygen onto the recording layer were initiated by irradiating them with a laser beam having an elliptic beam with wavelength of 810 nm, beam length of 75 mm and beam breadth of 1 mm. Then, the disk was rotated so as to obtain approximately 6 m/s of linear velocity, a semiconductor laser beam with wavelength of 660 nm was collected by a objective lens of NA 0.6 and was irradiated through the substrate onto the recording layer so that recording and regeneration were performed. For recording, waveforms with laser power modulated between 5 mW and 11 mW was used so that 8-16 modulated random signals were recorded. A record mark was formed with a power of 11 mW, and direct overwrite for carrying out elimination with a power of 5 mW was performed. However, a multi-pulse record waveform dividing a record pulse other than the shortest mark into two or more was used. Recording was made on both the grooves and lands.

After the jitter of the signal recorded as described above was measured, an accelerated test of keeping the disk under an atmosphere of 90° C. and 80% for 100 hours was performed, and subsequently the jitter was measured again. Jitters before and after the accelerated test with the respective various contents and concentrations of oxygen in the recording layer are shown below. Furthermore, an Auger electron analysis method was used for measuring the content of oxygen in the recording layer.

TABLE 1

| | | Gas | Oxygen | Jitter (%) | |
|---|---|---|---|---|---|
| | mixed gas | inflow | amount | Before | After |
| | flow rate | time | (atomic | accelerated | accelerated |
| | (SCCM) | (seconds) | %) | test | test |
| Sample 1 | 200 | 40 | 25 | 10.0 | 10.0 |
| Sample 2 | 200 | 30 | 20 | 8.5 | 8.5 |
| Sample 3 | 200 | 22 | 15 | 8.3 | 8.5 |
| Sample 4 | 200 | 20 | 14 | 8.0 | 8.3 |
| Sample 5 | 200 | 10 | 8 | 8.0 | 8.3 |
| Sample 6 | 200 | 3 | 3 | 7.5 | 8.5 |
| Sample 7 | 200 | 2 | 2 | 7.0 | 8.5 |

| | | | | |
|---|---|---|---|---|
| Sample 8 | No inflow gas | 1 | 7.0 | 18.5 |

Sample 8 whose recording layer was not sufficiently oxidized shows significant increase in jitter after the accelerated test in comparison with Samples 1 to 7. Also, Sample 1 to which the longest gas inflow time was applied showed no change in jitter before and after the accelerated test, but its initial jitter was much worse than those of Samples 2 to 8. Furthermore, in aforesaid Samples 1 to 7, mixed gas including oxygen was supplied after formation of the recording layer to oxidize the recording layer, but the recording layer may also be oxidized by forming the recording layer with sputtering in the environment of mixed gas of argon and oxygen.

Furthermore, in the condition described above, in the case where the recording layer with the content of Ge varied in the range of 10 to 30 atomic %, the content of Sb varied in the range of 10 to 30 atomic %, and the content of Te varied in the range of 40 to 80 atomic % was used, or in the case where the recording layer with the content of Ge varied in the range of 35 to 65 atomic %, the content of Sb varied in the range of 10 to 30 atomic % and the content of Te varied in the range of 35 to 65 atomic % was used, results similar to those described above were obtained.

Furthermore, in the case where a recording layer not including Ag was used, or in the case where a recording layer with the content of Ag varied in the range of 1 to 10 atomic %, similar results were obtained.

Furthermore, in the case where all or a part of Ag was replaced and at least one element of Au, Cu, Pd, Ta, W, Ir, Sc, Y, Ti, Zr, V, Nb, Cr, Mo, Mn, Fe, Ru, Co, Rh, Ni, Ag, Tl, S, Se, Pt and N was added in the range of 1 to 10 atomic %, similar results were obtained.

Furthermore, in the case where during the formation of the recording layer 4, the second recording layer 4a with thickness of 2 nm was formed using mixed gas of argon and oxygen as sputter gas, followed by changing the sputter gas to argon to form the first recording layer 4b with thickness of 16 nm, and changing the sputter gas again to mixed gas of argon and oxygen to form the second recording layer 4a with thickness of 2 nm again, while not carrying out oxidization process by inflow of argon-oxygen mixed gas after formation of the recording layer, the effect of increasing the reflectance of disks was obtained. When the partial pressure of oxygen during the formation of the second recording layer is changed to change the average content of oxygen of the second recording layer from 2 atomic % of the first recording layer to 20 atomic %, the increase in jitter by the accelerated test showed similar results to those shown in Table 1. In the case where the oxygen content of the first recording layer was ⅓ or less of the oxygen content of the second recording layer, the reflectance of the disk increased by 2%. When the second recording layer 4a was formed on only one side of the first recording layer 4b, properties very similar to those in the case of formation on both sides were obtained. Also, when thickness of the second recording layer 4a was varied in the range of 1 to 10 nm, very similar properties were obtained, but when the thickness became 5 nm or larger, record sensitivity decreased and power required for recording increased by approximately 1 mW.

[Embodiment 2]

A substrate 1a as in the case of Embodiment 1 was placed in a first sputtering chamber of sputtering equipment having a plurality of sputtering chambers and providing good uniformity and reproducibility of layer thickness. A first overlaid layer 2 of (ZnS)₈₀(Sio₂)₂₀ (80 and 20 represent mol %) with thickness of 90 nm was formed on the substrate 1a by sputtering in argon gas with a mixture of ZnS and SiO₂ as a target. Then, after this substrate was moved into a second sputtering chamber, a first protective layer 3 of Cr₂O₃ with thickness of 20 nm was deposited by sputtering in argon gas with Cr₂O₃ as a target. Further, after this substrate was moved into a third sputtering chamber, a recording layer 4 was deposited in thickness of 16 nm by sputtering in argon gas with sintered Ag_{2.5}Ge₂₀Sb_{22.5}Te₅₅ (2.5, 20, 22.5 and 55 represent atomic %) as a target. Then, the substrate was moved into an oxide formation chamber and was left in the environment of oxygen for a certain time period to oxidize the recording layer 4. Then, the substrate was moved into a fourth sputtering chamber and a second protective layer 5 of (ZnS)₈₀(SiO₂)₂₀ (80 and 20 represent mol %) with thickness of 18 nm was deposited by sputtering similarly to the formation of the first overlaid layer. Then, in a fifth sputtering chamber, a first reflecting layer 6 of Al₉₄Cr₆ (94 and 6 represent atomic %) was deposited in thickness of 35 nm by sputtering, with AlCr alloy as a target. Finally, in a sixth sputtering chamber, a second reflecting layer 7 of Al₉₉Ti₁ (99 and 1 represent weight %) was deposited in thickness of 35 nm by sputtering, with AlTi alloy as a target. The substrate with the deposited overlaid layer, protective layer, recording layer and reflecting layer was taken out of the sputtering equipment, and an ultraviolet cured resin protective layer 8 was formed on the second reflecting layer 7, by spin coating.

In a similar way, a first overlaid layer 2′ of (ZnS)₈₀(Sio₂)₂₀ (80 and 20 represent mol %), a protective layer 3′ of Cr₂O₃, a recording layer 4′, a second protective layer 5′ of (ZnS)₈₀(SiO₂)₂₀ (80 and 20 represent mol %), a first reflecting layer 6′ of Al₉₄Cr₆ (94 and 6 represent atomic %), a second reflecting layer 7′ of Al₉₉Ti₁ (99 and 1 represent weight %) and an ultraviolet cured resin protective layer 8′ are stacked in succession on another similar substrate 1b, and the two substrates were laminated in a face-to-face manner through an adhesive layer 9 with the ultraviolet cured resin protective layers 8,8′ inside the laminated substrates. At this time, when the diameter of the adhesive layer is 118 mm or larger, separation of the adhesive layer caused by impacts such as dropping was more unlikely to occur. On the recording layer 4′, oxidization process was performed similarly to the recording layer 4.

After the formation of the recording layers 4, 4′, a plurality of disk samples for each of two or more kinds of contents of Ge oxide and Sb oxide in the recording layer changed according to various partial pressures of oxygen and treatment time periods are prepared, each sample disk was initialized by a method as in the case of Embodiment 1, and subsequently a 8-16 modulated random signal is recorded thereon by a drive. After that, an accelerated test in which these disks were left in an atmosphere of 70° C. and 90% for forty days was carried out, a regeneration test in the drive was performed after the accelerated test, and a number of disks in which the error rate increased by twice or more times relative to that before the accelerated test was investigated. Further, on each sample after the initialization, the 8-16 modulated random signals are recorded repeatedly at a constant position of the disk using the drive, a number of regeneration or recording errors was investigated. A number of disks in which the errors increased by twice or more times when the contents of Ge oxide and Sb oxide in the recording layer were varied is shown in Table 2. The number of times of repeated recordings when the contents of Ge oxide and Sb oxide in the recording layer were varied is shown in Table 2. The contents of Ge oxide and Sb oxide were measured using XPS equipment and were determined by the peak separating of XPS spectra of Ge and Sb. Furthermore, in Table 2, a, b, c and d represent the content of oxidized Ge, the content of non-oxidized Ge of metal or alloy, the content of oxidized Sb and the content of non-oxidized Sb of metal and alloy, respectively.

TABLE 2

| | | | | | Number of disks | |
|---|---|---|---|---|---|---|
| | | | | | involving error | |
| | Oxygen | | | | rate increased | Number of |
| | partial | | | | by twice or more | times of |
| | pressure | keep time | | | times by | repeated |
| | (10⁻⁵Pa) | (minute) | a/(a + b) | c/(c + d) | accelerated test | recordings |
| sample 1 | 10.0 | 60 | 0.6 | 0.26 | 0/10 | 30000 |
| sample 2 | 5.0 | 10 | 0.5 | 0.2 | 0/10 | 100000 |
| sample 3 | 3.0 | 10 | 0.4 | 0.14 | 0/10 | 110000 |
| sample 4 | 1.0 | 10 | 0.2 | 0.07 | 1/10 | 130000 |
| sample 5 | 1.0 | 2 | 0.04 | 0.02 | 2/10 | 150000 |
| sample 6 | 1.0 | 1 | 0.02 | 0.01 | 3/10 | 200000 |

| | | | | | |
|---|---|---|---|---|---|
| sample 7 | Not oxidized | 0.01 | 0.005 | 8/10 | 200000 |

Sample 7 whose recording layer was not sufficiently oxidized showed significant increase in error rate after the accelerated test as compared with Samples 1 to 6, and not only error rates of eight samples in ten samples increased by twice or more times, but also in four of them, regeneration itself became significantly difficult.

Furthermore, in the condition described above, in the case where the recording layer with the content of Ge varied in the range of 10 to 30 atomic %, the content of Sb varied in the range of 10 to 30 atomic %, and the content of Te varied in the range of 40 to 80 atomic % was used, or in the case where the recording layer with the content of Ge varied in the range of 35 to 65 atomic %, the content of Sb varied in the range of 10 to 30 atomic % and the content of Te varied in the range of 35 to 65 atomic % was used, results similar to those described above were obtained.

Furthermore, in the case where a recording layer not including Ag was used, or in the case where a recording layer with the content of Ag varied in the range of 1 to 10 atomic %, similar results were obtained.

Furthermore, in the case where all or a part of Ag was replaced and at least one element of Au, Cu, Pd, Ta, W, Ir, Sc, Y, Ti, Zr, V, Nb, Cr, Mo, Mn, Fe, Ru, Co, Rh, Ni, Ag, Tl, S, Se, Pt and N was added in the range of 1 to 10 atomic %, similar results were obtained.

[Embodiment 3]

With the same technical limits as Embodiment 1 except that the radial distance between the center of the groove 1′ and the center of the neighboring groove was 0.75 μm, the substrate 1a was placed in a first sputtering chamber of sputtering equipment having a plurality of sputtering chambers and providing good uniformity and reproducibility of layer thickness. A first protective layer 2 of (ZnS)₈₀(SiO₂)₂₀ (80 and 20 represent mol %) with thickness of 90 nm was formed on the substrate 1a by sputtering in argon gas with a mixture of ZnS and SiO₂ as a target. Then, after this substrate was moved into a second sputtering chamber, a recording layer 4 was deposited in thickness of 20 nm by sputtering in argon gas with sintered Ag₄In₇Sb₆₂Te₂₇ (4, 7, 62 and 27 represent atomic %) as a target. Then, the substrate was moved into an oxide formation chamber and was kept in the environment of oxygen for a certain time period to oxidize the recording layer 4. Then, the substrate was moved into a third sputtering chamber and a second protective layer 5 of (ZnS)₈₀(SiO₂)₂₀(mol %) with thickness of 20 nm was formed similarly to the formation of the first protective layer. Then, in a fourth sputtering chamber, a reflecting layer 7 of Al₉₉Ti₁ (99 and 1 represent weight %) was deposited in thickness of 100 nm with AlTi alloy as a target. The substrate on which the protective layer, recording layer and reflecting layer were deposited was taken out of the sputtering equipment, and its top layer was coated with an ultraviolet cured resin protective layer 8 by spin coating.

In a similar way, a first protective layer 2′ of (ZnS)₈₀(SiO₂)₂₀ (80 and 20 represent mol %), a recording layer 4′, a second protective layer 5′ of (ZnS)₈₀(SiO₂)₂₀ (80 and 20 represent mol %), a reflecting layer 6′ of Al₉₉Ti₆ (99 and 1 represent weight %), and an ultraviolet cured resin protective layer 8′ are stacked in succession on another similar substrate 1b, and the two substrates were adhered to each other through an adhesive layer 9 in a face-to-face manner with the ultraviolet cured resin protective layers 8, 8′ inside the substrates. At this time, when the diameter of the adhesive layer is 118 mm or larger, separation at the adhesive layer caused by impacts such as dropping was more unlikely to occur. For the recording layer 4′, oxidization process was performed similarly to the case of the recording layer 4.

With the same technical limits as Embodiment 1 except that recording was performed only on the groove, the jitter of signals recorded as described above was measured, subsequently an accelerated test in which disks were kept in the atmosphere of 80° C. and 90% for 200 hours was carried out, and the jitter was measured after the accelerated test. The jitter measured before and after the accelerated test with various partial pressures of oxygen, keeping time thereof, and various contents of In oxide and Sb oxide in the recording layer is shown below. The contents of In oxide and Sb oxide in the recording layer were measured with XPS equipment, and were determined by the peak separating of XPS spectra of In and Sb. Furthermore, in Table 3, e, f, g and h represent the content of oxidized In, the content of non-oxidized In of metal or alloy, the content of oxidized Sb and the content of non-oxidized Sb of metal or alloy, respectively.

TABLE 3

| | Oxygen | | | | jitter (%) | |
|---|---|---|---|---|---|---|
| | partial | keep | | | before | after |
| | pressure | time | | | accelerated | accelerated |
| | (10⁻⁵Pa) | (minute) | e/(e + f) | g/(g + h) | test | test |
| sample 1 | 10.0 | 60 | 0.6 | 0.26 | 10.0 | 10.0 |
| sample 2 | 5.0 | 10 | 0.5 | 0.2 | 8.0 | 8.0 |
| sample 3 | 3.0 | 10 | 0.4 | 0.15 | 7.0 | 7.9 |
| sample 4 | 1.0 | 10 | 0.2 | 0.07 | 7.5 | 7.9 |
| sample 5 | 1.0 | 2 | 0.04 | 0.02 | 7.3 | 7.9 |
| sample 6 | 1.0 | 1 | 0.01 | 0.01 | 7.0 | 8.0 |

| | | | | | |
|---|---|---|---|---|---|
| sample 7 | Not oxidized | 0.005 | 0.005 | 6.7 | 15.0 |

In Sample 7 whose recording layer was not sufficiently oxidized, the jitter increased significantly after the accelerated test in comparison with Samples 1 to 6. Also, in Sample 1 of the longest keeping time, the jitters before and after the accelerated test are equal to each other, but its initial jitter was much worse than those of Samples 2 to 7.

Furthermore, in the aforesaid Samples 1 to 6, the recording layer was kept in the environment of oxygen for a certain time period to oxidize the recording layer, but the recording layer may also be oxidized by forming the recording layer in the environment of mixed gas of argon and oxygen.

Furthermore, under the condition described above, in the case where the recording layer with the content of Ag varied in the range of 1 to 15 atomic %, the content of In varied in the range of 1 to 15 atomic %, the content of Sb varied in the range of 45 to 80 atomic % and the content of Te varied in the range of 20 to 40 atomic % was used, results similar to those described above were obtained.

Furthermore, in the case where at least one element of Au, Cu, Pd, Ta, W, Ir, Sc, Y, Ti, Zr, V, Nb, Cr, Mo, Mn, Fe, Ru, Co, Rh, Ni, Tl, S, Se, Pt and N was added in the range of 1 to 10 atomic %, similar results were obtained.

[Embodiment 4]

A substrate 1a as used in Embodiment 1 was placed in a first sputtering chamber in sputtering equipment having a plurality of sputtering chambers and providing good uniformity and reproducibility of layer thickness. A first overlaid layer 2 of (ZnS)₈₀(SiO₂)₂₀ (mol %) with thickness of 90 nm was formed in argon gas with a mixture of ZnS and SiO₂ as a target. Then, after this substrate was moved into a second sputtering chamber, a first protective layer 3 of Cr₂O₃ with thickness of 20 nm was formed in argon gas with Cr₂O₃ as a target. Further, after this substrate was moved into a third sputtering chamber, a recording layer 4 was formed in thickness of 16 nm in argon gas with sintered Ag_{2.5}Ge₂₀Sb_{22.5}Te₅₅ (atomic %) as a target. Then, a mixed gas of argon and oxygen with partial pressure of oxygen being 10% is flowed in the third sputtering chamber at a flow rate of 200 SCCM for a certain time period to oxidize the surface of a recording layer 4. Then, the substrate was moved into a fourth sputtering chamber, and a second protective layer 5 of ZnS—SiO₂—N with thickness of 18 nm was formed in mixed gas of argon and nitrogen. Then, in a fifth sputtering chamber, a first reflecting layer 6 of Al₉₄Cr₆ (atomic %) was formed in thickness of 35 nm, with AlCr alloy as a target. Finally, in sixth sputtering chamber, a second reflecting layer 7 of Al₉₉Ti₁ (weight %) was formed in thickness of 35 nm, with AlTi alloy as a target. The substrate with the stacked layers was taken out of the sputtering equipment, and an ultraviolet cured resin protective layer 8 was formed on the top layer by spin coating. In a similar way, a first overlaid layer 2′ of (ZnS)₈₀(SiO₂)₂₀ (mol %), a protective layer 3′ of Cr₂O₃, a recording layer 4′, a second protective layer 5′ of ZnS—SiO₂—N, a first reflecting layer 6′ of Al₉₄Cr₆ (atomic %), a second reflecting layer 7′ of Al₉₉Ti₁ (weight %) and an ultraviolet cured resin protective layer 8′ were formed on another similar substrate 1b, the two substrates were adhered to each other through an adhesive layer 9 in a face-to-face manner with the ultraviolet cured resin protective layers 8, 8′ inside the laminated substrates. At this time, when the diameter of the adhesive layer is 118 mm or larger, separation at the adhesive layer caused by impacts such as dropping was more unlikely to occur.

A several kinds of disks as described above were prepared, 8-16 modulated random signals were recorded by using the drive to measure the error rate, an accelerated test in which the disks were kept in the atmosphere of 90° C. and 80% for 100 hours was then performed, the error rate (regeneration error rate) of the same place was measured after the accelerated test, and the random signal was overwritten on the same place to measure the error rate (overwrite error rate). A number of disks in which error rate increased by twice or more times after the accelerated test when keeping the content of oxygen in the recording layer constant, i.e. 8 atomic % and setting various concentrations of nitrogen in mixed gas of argon and nitrogen during formation of the second protective layer of ZnS—SiO₂—N so that the content of nitrogen in the second protective layer of ZnS—SiO₂—N was changed is shown below. Furthermore, the Auger electron spectral method was used for measuring the content of oxygen in the recording layer and the content of nitrogen in the second protective layer.

TABLE 4

| | A number of disks | A number of disks |
|---|---|---|
| | with overwrite | with regeneration |
| | error rate | error rate |
| | increased by | increased by |
| | twice or more | twice or more |
| | times after | times after |
| nitrogen content | accelerated test | accelerated test |
| in second | (number in ten | (number in ten |
| protective layer | disks) | disks) |
| 0% | 10/10 | 0/10 |
| 1% | 1/10 | 0/10 |
| 2% | 0/10 | 0/10 |
| 15% | 0/10 | 0/10 |
| 25% | 0/10 | 1/10 |
| 50% | 0/10 | 2/10 |
| 60% | 0/10 | 9/10 |

In the case where the content of nitrogen in the second protective layer was set to 60 atomic %, not only nine disks in ten disks increased in regeneration error rate by twice or more times, but also eight disks thereof showed a phenomenon in which regeneration itself was extremely difficult. Also, in the cases of the contents of nitrogen being 50 atomic % and 25 atomic %, there existed some disks that increased in regeneration error rate by twice or more times, but in these disks, a phenomenon in which regeneration was difficult was not found.

[Embodiment 5]

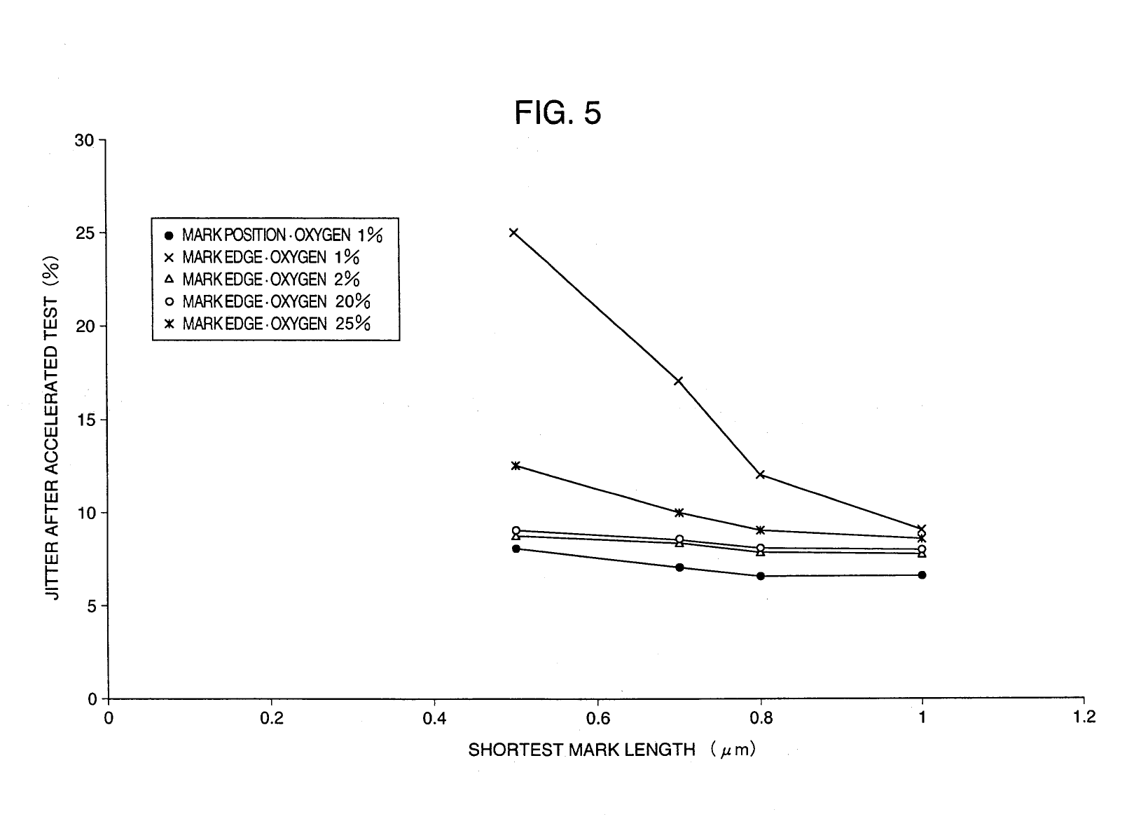

After marks of various shortest mark lengths were recorded on disks formed similarly to Embodiment 1 with shortest mark length being varied, the accelerated test in which the disks were kept in the environment of temperature of 90° C. and relative humidity of 80% for 100 hours was carried out, and the jitters were measured after the accelerated test. The radial distance between the center of groove 1′ and the adjacent land 1″ was set to 0.74 μm and the recordings were carried out on both the groove and land. Both the mark position system in which “1” state information is set at the mark and “0” state information is set at a portion other than the mark and the mark edge system in which the “1” state information is set at an edge of the mark and the “0” state information is set at a portion other than the edge of the mark were examined. The jitters with various respective contents of oxygen in the recording layer after the accelerated test changed as shown in FIG. 5.

[Embodiment 6]

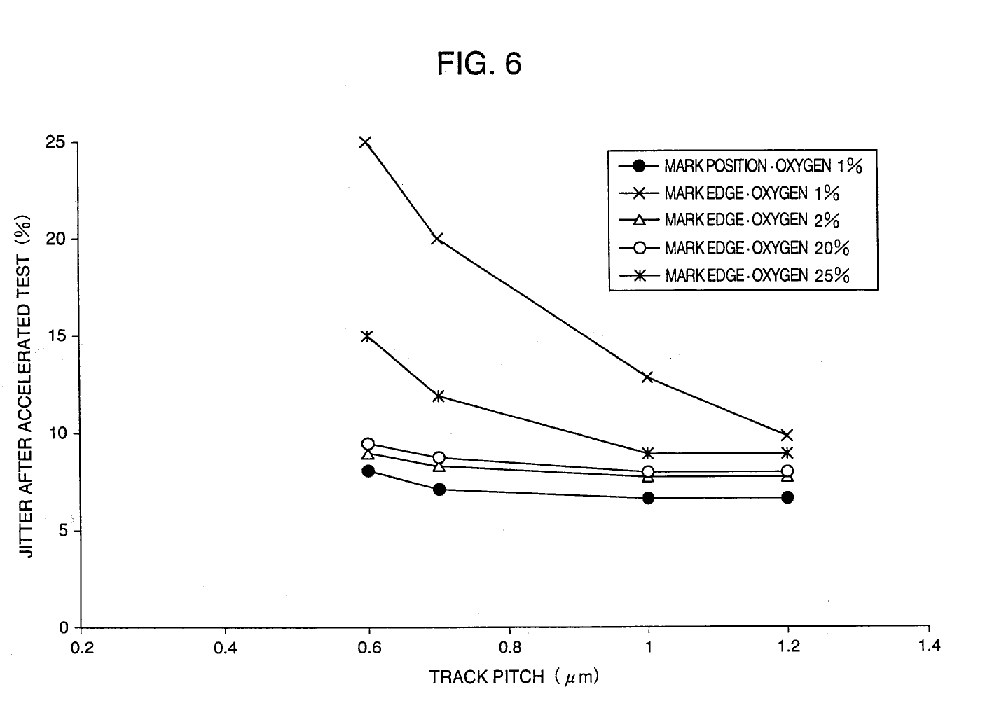

Several kinds of substrates 1a which were formed of transparent material (for example, polycarbonate resin, glass or the like) with diameter of 120 mm and thickness of 0.6 mm and included the juxtaposed radially and extending substantially circumferentially grooves 1′ and lands 1″ (that is, on a concentric or helical surface shape) as shown in FIG. 2 and which were different from each other in distance between the center of the groove 1′ and the center of the adjacent land 1″ were prepared. After marks of shortest mark length of 0.7 μm were recorded onto the disks formed on these substrates similarly to Embodiment 1, the accelerated test in which the disks were kept in the environment of temperature of 90° C. and relative humidity of 80% for 100 hours was carried out, and the jitters were measured after the accelerated test. Both the mark position system in which “1” state information is set at the mark and “0” state information is set at a portion other than the mark and the mark edge system in which the “1” state information is set at an edge of the mark and the “0” state information is set at a portion other than the edge of the mark were examined. The jitters with various respective contents of oxygen in the recording layer after the accelerated test changed as shown in FIG. 6.

[Embodiment 7]

Substrates 1a which were formed of transparent material (for example, polycarbonate resin, glass or the like) with diameter of 120 mm and thickness of 0.6 mm and included the juxtaposed radially and extending substantially circumferentially grooves 1′ and lands 1″ (that is, on a concentric or helical surface shape) as shown in FIG. 2 and on which the groove 1′ or land 1″ was divided circumferentially to a plurality of groove portions or land portions and, embossed pits showing address information were formed between the groove portions or land portions substantially along a circumferential direction along which the groove 1′ or land 1″ extended were prepared. After the disks were formed on these substrate similarly to Embodiment 1 and the recordings were carried out by 10000 times on both the groove 1″ and land 1″ as recording tracks, the accelerated test in which the disks were kept in the environment of temperature of 90° C. and relative humidity of 80% for 100 hours was carried out. A relationship among the content of oxygen in the recording layer on an area of the groove 1′ or land 1″ on which the recordings were carried out by ten thousand times, that is, a first area in which information could be recorded, the content of oxygen in the recording layer on an area on which the emboss pits indicating address informations or the like were formed, that is, a second area for performing only regeneration of predetermined informations, and a relationship in reflectance between the first and second areas changed with a variation of time period for being kept in an accelerating condition as shown below.

TABLE 5

| | | | difference | difference |
|---|---|---|---|---|
| | | | in oxygen | in |
| | | | content | reflectance |
| | oxygen | oxygen | between | between |
| | content | content | first and | first and |
| keeping | on first | on second | second | second |
| time | area | area | areas | areas |
| 0 hour | 4% | 2% | 2% | 0% |
| 50 hours | 8% | 2% | 6% | 0-1% |
| 100 hours | 10% | 2% | 8% | 1% |
| 200 hours | 15% | 2% | 13% | 2% |
| 300 hours | 20% | 3% | 17% | 4% |
| 500 hours | 22% | 4% | 18% | 5% |
| 1000 hours | 25% | 5% | 20% | 8% |

1. An information recording method for recording a signal on a recording layer of a substrate by transforming partially the recording layer between crystalline state and amorphous state, comprising the steps of:
heating a first part of the recording layer to be melted, and
cooling the first part of the recording layer to be cured so that a signal mark surrounded by a second part of the recording layer other than the first part of the recording layer is formed, the recorded signal involves “0” state and “1” state, one of the “0” state and the “1” state to be recorded is defined by at least a part of a boundary between the first and second parts of the recording layer, and the recorded one of the “0” state and the “1” state is recognized at the at least a part of the boundary,
wherein the substrate includes a plurality of juxtaposed recording tracks on which the signal is recorded, a distance between the recording tracks is not more than 0.7 μm,
a minimum circumferential length of the first part of the recording layer is not more than 0.7 μm, and
the recording layer includes an oxygen content of 2-20 atom %, based on the total content of atoms in the recording layer.

2. An information recording method according to claim 1, wherein the oxygen content increases from a substantially middle point of the recording layer toward at least one surface of the recording layer in a thickness direction.

3. An information recording method according to claim 1, wherein the oxygen content increases from a substantially middle point of the recording layer toward at least one surface of the recording layer in a thickness direction by at least two times the oxygen concentration at the substantially middle point of the recording layer.
